(19) United States
(12) Patent Application Publication
(10) Pub. No.: US 2008/0094794 A1
(43) Pub. Date: Apr. 24, 2008

(54) Hard drive carrier assembly having interlocking parts

(76) Inventor: Kenneth Hass, Longmont, CO (US)

Correspondence Address: LSI CORPORATION, 1621 BARBER LANE, MS: D-106, MILPITAS, CA, 95035, US

(21) Appl. No.: 11/584,031

(22) Filed: Oct. 20, 2006

(51) Int. Cl. G06F 1/16

(52) U.S. Cl. 361/685

(57) ABSTRACT

In some embodiments, an apparatus to carry a hard drive may include one or more of the following features: (a)at least one carrier component, (b) at least one interlocking portion located on the at least one carrier component, (c) a first connector located at the at least one interlocking portion that can be received by a second connector, (d) a second carrier component, (e) a second interlocking portion, and (f) a third and fourth connector located at the second interlocking portion.

### FIELD OF THE INVENTION

The present disclosure relates generally to computer systems and information handling systems, and, more particularly, to a hard drive carrier for a computer system or information handling system.

### BACKGROUND OF THE INVENTION

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Information handling system or computer system may include a hard drive that is coupled to the chassis of a computer or a drive bay. A hard drive is typically disposed on a carrier assembly, often referred to as a hard drive carrier, and the carrier assembly is inserted, via a guide rail system, into a bay in a computer chassis. The hard drive carrier serves as a protective housing for the hard drive and mechanically mates with a drive bay in a computer chassis.

With reference to FIG. 1, a prior art drive carrier assembly is shown. Drive and drive carrier assembly 10 has a hard drive unit 12, and a drive carrier 14. All current drive carrier assemblies have some physical connection between drive carrier 14 and drive unit 12. For example, screws 16 which are used to attach drive carrier 14, securing bracket 18, and tongue 20 to drive unit 12. One disadvantage of drive carrier 14 is that it requires tools (e.g., a screwdriver) and retaining hardware (e.g., screws) in the assembly of the drive and drive carrier. Current practices for assembling drives and carriers require a lot of physical contact with the drives (e.g., getting screws aligned, threaded, and in place). This contact increases the risk of electrostatic discharge (ESD) and/or mechanical damage to the drive unit.

Further, typical assembly requires a number of hardware components in the form of screws and washers, thus increasing the complexity of the assembly and the associated cost. In addition, some carrier assemblies are slid upon the drive before they are attached. This action raises ESD concerns as well

Therefore, it would be desirable to provide an assembly that can eliminate the need for tools and retaining hardware in the assembly of drive and drive carrier assemblies.

### SUMMARY OF THE INVENTION

In some embodiments, an apparatus to carry a hard drive may include one or more of the following features: (a) at least one carrier component, (b) at least one interlocking portion located on the at least one carrier component, (c) a first connector located at the at least one interlocking portion that can be received by a second connector, (d) a second carrier component, (e) a second interlocking portion, and (f) a third and fourth connector located at the second interlocking portion.

In some embodiments, a carrier unit that can carry a hard drive may include one or more of the following features: (a) a carrier component having a first connector at a first end and a second connector at a second end; and (b) an interlocking portion on the carrier component where the first connector can be received by the second connector and held firm with no additional action.

In some embodiments, a method for attaching a drive carrier to a hard drive may include one or more of the following steps: (a) placing a carrier component about the hard drive; (b) bringing an interlocking portion together; and (c) connecting adjoining connectors.

### BRIEF DESCRIPTION OF THE DRAWINGS

The numerous advantages of the present invention may be better understood by those skilled in the art by reference to the accompanying figures in which:

FIG. 1 illustrates a prior art drive carrier assembly;

FIG. 2 illustrates a drive carrier assembly in an embodiment of the present invention;

FIG. 3 illustrates a drive carrier assembly in an embodiment of the present invention;

FIG. 4 illustrates a drive carrier assembly in an embodiment of the present invention;

FIG. 5 illustrates a drive carrier assembly in an embodiment of the present invention;

FIG. 6 is a flow chart diagram for connecting a drive carrier to a hard drive in an embodiment of the present invention;

FIG. 7 illustrates a drive carrier assembly in an embodiment of the present invention.

### DETAILED DESCRIPTION OF THE INVENTION

Reference will now be made in detail to embodiments of the invention, examples of which are illustrated in the accompanying drawings.

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

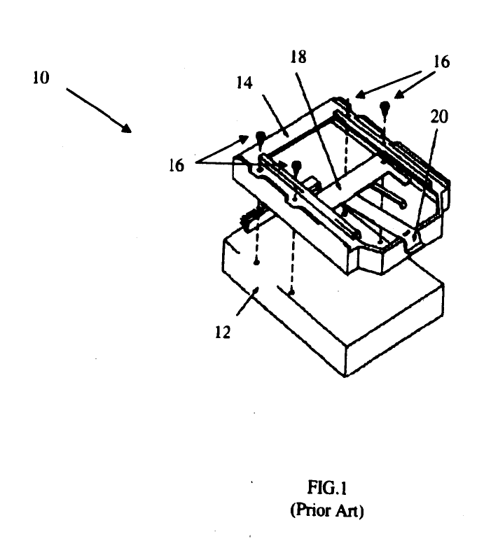

In embodiments of the present invention, a drive carrier would have at least one interlocking part that would capture the drive unit in place. Any number of materials could be used (e.g., metal or most any polymer) so long as the connection mechanism had sufficient tension strength to maintain the connection. This could be achieved by setting material thickness requirements, grounding specifications, ESD shielding, or other specific needs of a given implementation of embodiments of the present invention. The materials used are not critical, so long as the materials meet the physical needs for the carrier and the disclosed method. However, for non-conductive materials, some form of ground for the drive to the main chassis should be provided. One way to do this is to embed metal “fingers” on the inside edge of the drive carrier, with some element of the metal piece making its way to outside edge of the carrier as is described in more detail below. Thus, when the drive is captured in the carrier, it provides electrical continuity from the drive casing, to the embedded metal fingers, to the outside of the drive carrier, which, when inserted in the system chassis it is grounded. Further, embodiments of the present invention could include alignment pins located on the drive carrier so as to align with existing drive unit mounting holes as shown in FIG. 1. Embodiments of the present invention can reduce the amount of physical handling of drives during carrier unit assembly. Embodiments of the present invention can also reduce the amount of parts used in the carrier unit assembly and can also create a tool-less carrier unit assembly.

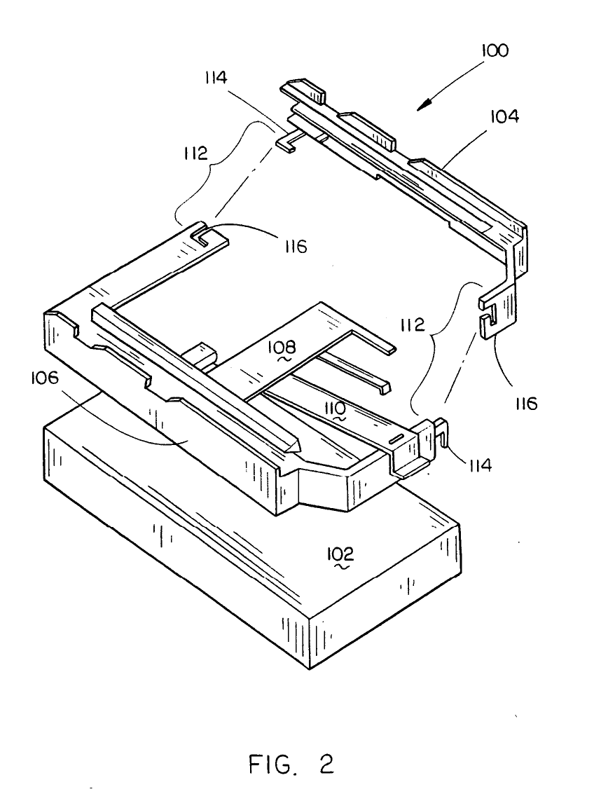

With reference to FIG. 2, a drive carrier assembly in an embodiment of the present invention is shown. Carrier unit 100 is shown in relation to drive 102. Carrier unit 100 can have two carrier components, component 104 and component 106. Carrier unit 100 can also have securing bracket 108 and tongue portion 110. These elements will commonly have a thin metal underside to provide ESD protection by creating a digital ground. Carrier unit 100 can also have interlocking portions 112, having male puzzle piece connectors 114 and female puzzle piece connectors 116.

In operation, the carrier unit installer would place carrier components 104 and 106 around drive 102, hopefully with minimal human contact so as to reduce any risk of ESD. The installer would then place male puzzle piece connectors 114 within female puzzle piece connectors 116. This could be done one interlocking portion 112 at a time or both at one time. Regardless, when male puzzle piece connectors 114 are within female puzzle piece connectors 116 a firm grip is created on disk drive 102. Thus, drive 102 is ready to be placed within a RAID (redundant array of independent disks) system, JBOD (just a bunch of disks) system, a server, or even a personal computer. If it was ever desired to remove carrier unit 100 from drive 102, an operator could simply slide male puzzle piece connectors 114 away from drive 102 thus releasing them from female puzzle piece connectors 116. This would release component 104 from component 106 thus releaseing carrier unit 100 from drive 102.

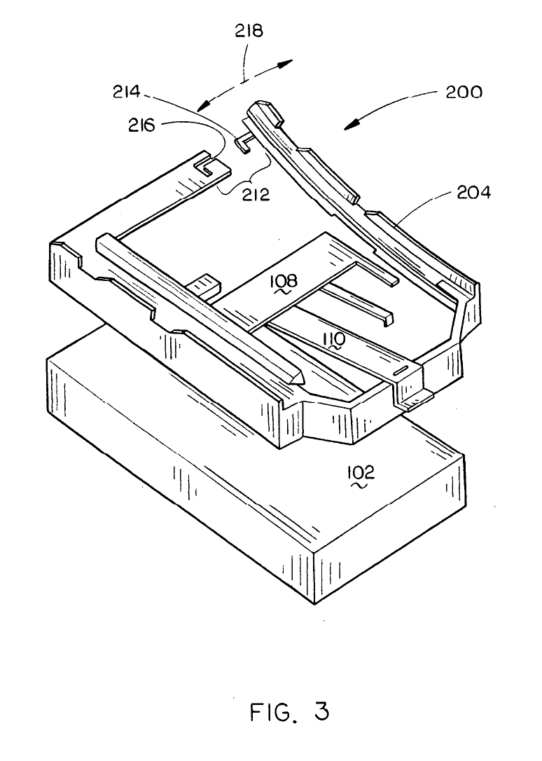

With reference to FIG. 3, a drive carrier assembly in an embodiment of the present invention is shown. In the embodiment of FIG. 3 carrier unit 200 can have only one carrier component 204. Carrier component 204 could be made from a polymer so that it can be flexible. In this fashion, connector 214 can be pulled outward as shown by arrow 218. The operator would then place carrier unit 200 around drive 102 and bring interlocking portion 212 back together as shown by arrow 218. As interlocking portion 212 comes back together, connectors 214 and 216 could then be mated together to firmly hold carrier unit 200 to drive 102. This embodiment reduces the amount of carrier components to one thus reducing the amount of connecting activity by the operator and reducing the amount of component materials. Carrier unit 100 could be released from drive 102 in a similar fashion to that described above.

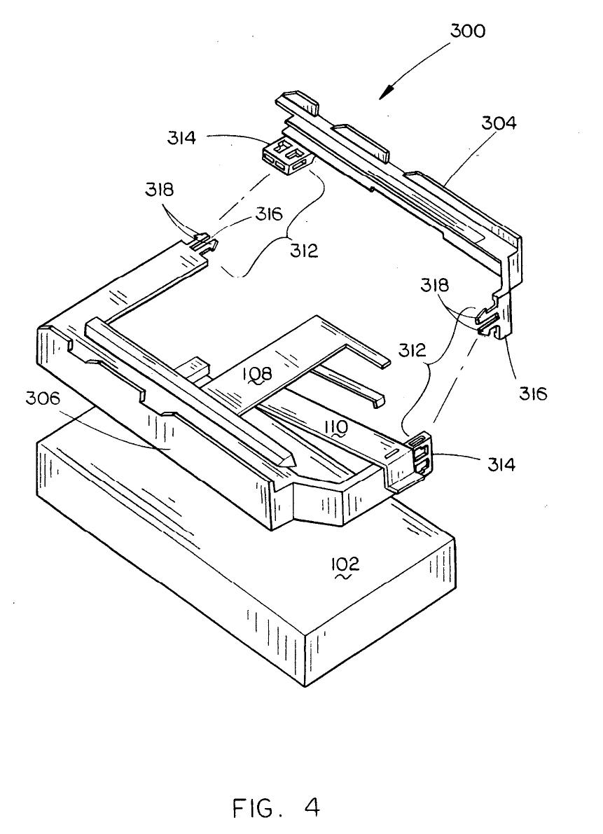

With reference to FIG. 4, a drive carrier assembly in an embodiment of the present invention is shown. In this embodiment carrier unit 300 has snap fit connectors 314 and 316 located and interlocking portions 312. Carrier components 304 and 306 could be brought together by the assembly technician where male snap fit connector 316 could be received by female snap fit connector 314. If an operator ever desired to remove carrier unit 300 from drive 102, for example if drive 102 was bad, the operator could simply press down on tabs 318 with their fingers thus releasing male snap connector 316 from female snap connector 314. This action would then release carrier component 304 from carrier component 306 and thus release carrier unit 300 from drive 102.

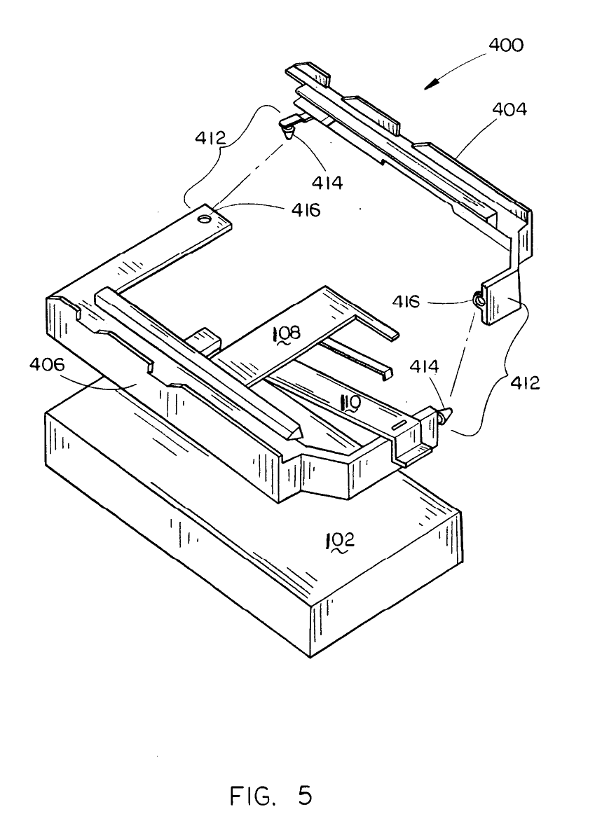

With reference to FIG. 5, a drive carrier assembly in an embodiment of the present invention is shown. In this embodiment carrier unit 400 has plug fit connectors 414 and 416. Carrier components 404 and 406 could be coupled to drive 102 by putting them into place around the periphery of drive 102. The operator could then move components 404 and 406 together so that interlocking sections 412 are aligned to allow male plug 414 to be received by female plug 416. In this embodiment, male plug 414 would probably not be able to be separated from female plug 416. Thus when drive 102 would go bad, carrier unit 400 would be discarded with drive 102.

With reference to FIGS. 2, 4, and 5, it can be seen that interlocking portions 112, 312, and 412 have a 90 degree different planar orientation. This allows the operator to easily align the correct interlocking portions 112, 312, and 412 and insures that carrier units 100, 300, and 400 are correctly put together around drive 102.

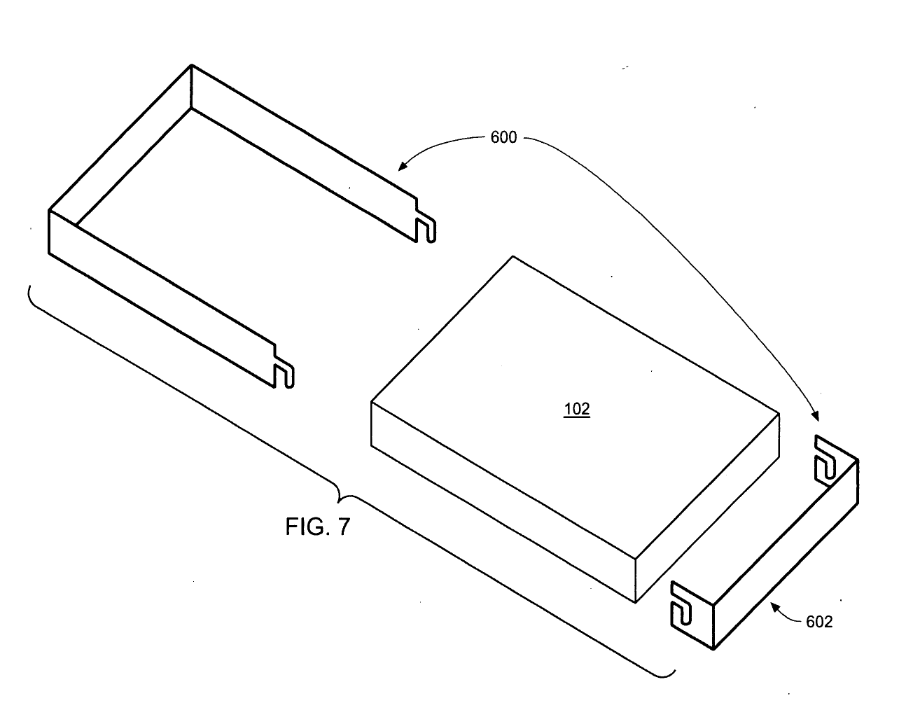

It is fully contemplated any type of connectors could be used to couple a carrier unit to a drive, such as those discussed in detail below, without departing from the spirit of the invention. It is fully contemplated that the interlocking portions could be located anywhere on the carrier units without departing from the spirit of the invention. It is fully contemplated there could be more than two interlocking portions on the carrier unit without departing from the spirit of the invention. The carrier unit could be a four-piece unit where the corners are interlocked, however, this would increase the number of parts. Carrier unit 600 could have a “horseshoe” design (shown in FIG. 7) that captures drive 102 by interlocking a handle 602 on the front to close carrier unit 600 using any one of the above described methods.

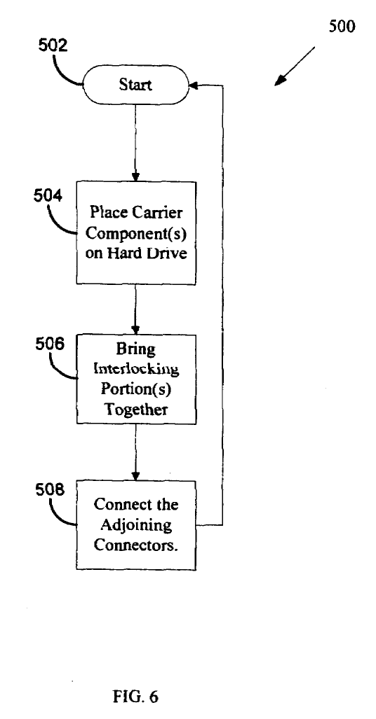

With reference to FIG. 6, a flow chart diagram for connecting a drive carrier to a hard drive in an embodiment of the present invention is shown. Carrier drive assembly operation 500 begins at state 502 with the hard drives arriving at the assembly station. At state 504 the assembly person places any one of the carrier components discussed above about the periphery of the hard drive. It is helpful if the assembly person does not touch the hard drive. At state 506, the interlocking portions, specifically the connectors, are brought together. At state 508, the connecters are adjoined in any type fashion as is discussed above in detail. The assembly person then moves to the next hard drive and begins carrier drive assembly operation 500 all again at state 502.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. Features of any of the variously described embodiments may be used in other embodiments. The form herein before described being merely an explanatory embodiment thereof. It is the intention of the following claims to encompass and include such changes.

What is claimed is:

1. An apparatus to carry a hard drive, comprising:
at least one carrier component;
at least one interlocking portion located on the at least one carrier component; and
a first connector located at the at least one interlocking portion that can be received by a second connector.

2. The apparatus of claim 1, further comprising a second carrier component.

3. The apparatus of claim 2, further comprising a second interlocking portion.

4. The apparatus of claim 3, further comprising a third and fourth connector located at the second interlocking portion.

5. The apparatus of claim 4, wherein the third connector can be received by the fourth connector.

6. The apparatus of claim 1, wherein the first connector is a male puzzle piece connector.

7. The apparatus of claim 6, wherein the second connector is a female puzzle piece connector.

8. A carrier unit that can carry a hard drive comprising:
a carrier component having a first connector at a first end and a second connector at a second end; and
an interlocking portion on the carrier component where the first connector can be received by the second connector and held firm with no additional action.

9. The carrier unit of claim 8, wherein no tools are required to connect the first connector to the second connector.

10. The carrier unit of claim 8, wherein the first connector can be a male puzzle piece and the second connector can be a female puzzle piece.

11. The carrier unit of claim 8, wherein the first connector can be a male snap fit connector and the second connector can be a female snap fit connector.

12. The carrier unit of claim 8, wherein the first connector can be a male plug type connector and the second connector can be a female plug connector.

13. The carrier unit of claim 8, wherein the carrier component can be made of a polymer capable of forming around the hard drive.

14. A method for attaching a drive carrier to a hard drive, the steps comprising:
placing a carrier component about the hard drive;
bringing an interlocking portion together; and
connecting adjoining connectors.

15. The method of claim 14, wherein the adjoining connects can be a male puzzle piece connector and a second puzzle piece connector.

16. The method of claim 14, wherein the carrier component is a flexible polymer.

17. The method of claim 14, wherein the carrier component is made of metal.

18. The method of claim 14, wherein there can be multiple carrier components.

19. The method of claim 14, wherein the connectors are connected without any tools.

20. The method of claim 14, wherein the adjoining connectors could be a male snap fit connector and a female snap fit connector.
